(19) United States
(12) Patent Application Publication
(10) Pub. No.: US 2014/0370169 A1
(43) Pub. Date: Dec. 18, 2014

(54) PELLETS COMPRISING STARCH

(71) Applicant: Cargill, Incorporated, Wayzata, MN (US)

(72) Inventor: Nicole S. J. De Cock, Vilvoorde (BE)

(73) Assignee: Cargill, Incorporated, Wayzata, MN (US)

(21) Appl. No.: 14/374,150

(22) PCT Filed: Jan. 21, 2013
(86) PCT No.: PCT/EP2013/000169

§ 371 Date: Jul. 23, 2014

(30) Foreign Application Priority Data
Jan. 25, 2012 (EP) 12000482.5

(51) Int. Cl. A23L 1/164; A23L 1/00

(52) U.S. Cl. CPC A23L 1/1646; A23L 1/0073
USPC 426/285; 426/656

(57) ABSTRACT

The invention relates to pellets comprising starch and further comprising protein. A process to make pellets of the present invention is also disclosed. Further, use of the pellets as an ingredient to make food-, pet food- and feed compositions is also disclosed: the pellets can be ground and mixed with other ingredients to make food-, pet food- or feed compositions. In particular, use of the pellets to make -fish feed compositions is disclosed.

### FIELD OF THE INVENTION

The invention relates to pellets comprising starch and further comprising protein. A process to make the pellets of the present invention is also disclosed. Further, use of the pellets as an ingredient to make food-, pet food- and feed compositions is also disclosed: the pellets can be ground and mixed with other ingredients to make food-, pet food- or feed compositions. In particular, use of the pellets to make fish feed compositions is disclosed.

### BACKGROUND OF THE INVENTION

Bulk transportation of many products in powder form necessitates a lot of care due to dust formation, health and explosion hazards, waste of product, etc, especially during loading and unloading of the product. Also, a lot of cleaning is necessary to remove dust and, in the case of organic products, to prevent proliferation of microorganisms. Moreover, unsuitable free flowing properties of powders often cause difficult loading, discharging and transportation operations.

Different solutions exist in the art to reduce or avoid the problems mentioned previously.

One solution is packaging of the product. However, this has the disadvantage of being non-environmentally friendly due to a high amount of waste, and causes extra work and costs. Also during packaging, dust formation and related health hazards and explosion risks cannot be entirely eliminated.

Another solution is to transport powders under pellet form. This is already done for a number of products, such as proteins.

WO01/25414 describes a process whereby a formable mixture or dough is obtained by supplying a plasticizable matrix with high amounts of liquid. Said formable mixture is subsequently formed into pieces.

Nowadays, it is common for food, feed and pet food producers, to receive their protein sources, such as commercial vital wheat gluten, in pellet form. Upon reception the pellets are milled and the protein is included in food-, feed- or pet food compositions. In addition to proteins, food-, feed- and pet food compositions typically comprise other nutrients (starches, fats, fibres . . . ), vitamins, minerals, processing aids and the like. So far most of these ingredients are still transported individually; most of them being transported in powder form. Additionally, storage of product in powder form requires special measures. Powders are often highly hygroscopic such that their conservation is limited in time or need controlled storage conditions.

All the ingredients need to be transported, stored, administratively handled, weighed separately, which amounts to a lot of work for the food-, feed- and pet foods producers. It is however true that a pellet comprising starch and protein, in amounts that can be easily adapted to the need of the producer, would simplify to a great extend the handling of ingredients that needs to be done by the producers of food, feed and pet foods. The right amount of starch and protein would then be directly available. However, the combination of proteins with relatively high moisture containing products, can be a disadvantage in processing.

There is thus a need for a pellet comprising starch and protein, with favourable flowing properties facilitating discharging and internal transport, resistant to harsh transport conditions and which can be easily milled.

There is also a need to provide a pellet comprising starch and protein which have not been degraded by the pelletizing process so that the physico-chemical properties of the components of the ground pellet are in fact similar to the properties of the components before pelletizing.

There is also a need to have powders in pellet form such that their hygroscopicity is reduced and they can be stored for a longer period of time in cheap and simple bins without any product deterioration.

The present invention provides for such a pellet, a process to make such a pellet and uses thereof.

### SUMMARY OF THE INVENTION

In one aspect, the present invention relates to a pellet comprising starch, characterized in that:
it further comprises from 5 to less than 75 weight/weight % (w/w %) protein, based on the dry weight of the pellet,
it has a moisture content of 20 weight/weight % (w/w %) or less.

In another aspect, the present invention relates to a process for making a pellet.

In another aspect, the present invention relates to a method for making food-, feed- or pet food compositions or their ingredients, comprising grinding the pellet, and mixing it with other ingredients.

In another aspect, the present invention relates to the use of the pellets of the present invention as ingredient of food-, feed- and pet food compositions.

### DETAILED DESCRIPTION

In one aspect, the present invention relates to a pellet comprising starch, characterized in that:
it further comprises from 5 to less than 75 weight/weight % (w/w %) protein, based on the dry weight of the pellet, and
it has a moisture content of 20 weight/weight % (w/w %) or less.

A pellet encompasses grains, granules and the like. Those pellets for example are typically of a cylindrical shape. Cylindrically shaped pellets typically have an average diameter of about 2 to 20 mm, preferably 3 to 20 mm, more preferably 2 to 18. Cylindrically shaped pellets further typically have an average length of about 0.5 to 6 cm, preferably 1 to 6 cm. Typically such pellet is only slightly to not expanded. A pellet can be obtained by compressing powder. A powder material may also be shaped into a pellet after addition of a binder.

The moisture content of the pellet of the present invention is 20 w/w % or less. The moisture content can be from 6 to 20 w/w %, from 6 to 18 w/w %, from 8 to 16 w/w %, from 10 to 15 w/w %. Moisture content is measured by grinding the pellet to a particle size smaller than 500 μm, drying at 103° C. in an oven during 4 hours and calculating the moisture content from the weight loss.

The pellets of the present invention comprise both starch and protein. This way, producers of food-, feed- and pet food compositions or products receive the starch and protein combined in a pellet, in a ratio as prescribed by the end application. After grinding, said pellets are used as an ingredient, to the make food-, feed- or pet food compositions. This means less weighing steps, less handling and higher cost efficiency during food-, feed and pet food manufacturing processes.

For the purpose of the present invention, the pellet comprises preferably at least 20 w/w % starch, measured on dry base of the pellet (w/w % db). In some embodiments, the level of starch can be at least 30 w/w % db, at least 40 w/w % db, at least 50 w/w % db, at least 60 w/w % db, at least 70 w/w % db, at least 80 w/w % db or at least 90 w/w % db.

The starch used to make the pellet can be derived from any source (starch source). The starch used for the current invention is obtained from a source selected from the group of native leguminous starch, native cereal starch, native root starch, native tuber starch, native fruit starch, native algae starch, modified leguminous starch, modified cereal starch, modified root starch, modified tuber starch, modified fruit starch, modified algae starch, waxy type starches, high amylose starches or mixtures thereof. Typical sources for the starch are cereals, tubers, roots, legumes, fruit, algae and hybrid starches. Suitable sources include but are not limited to wheat, corn, pea, potato, sweet potato, sorghum, banana, barley, rice, sago, amaranth, tapioca, arrowroot, cane and low amylose (containing no more than about 10% by weight amylose, preferably no more than 5%) or high amylose (containing at least about 40% by weight amylose) varieties thereof. Also suitable are starches derived from a plant obtained by breeding techniques including crossbreeding, translocation, inversion, transformation or any other method of gene or chromosome engineering to include variations thereof. In addition, starch derived from a plant grown from artificial mutations and variations of the above generic composition, which may be produced by, known standard methods of mutation breeding, are also suitable herein. Modifications are intended to include chemical modifications and/or physical modifications. The chemical modifications are intended to include without limitation, acetylated starches, hydroxyethylated and hydroxypropylated starches, inorganically esterified starches, cationic, anionic, oxidized starches, zwitterionic starches, starches modified by enzymes, and combinations thereof. Physically modified starches such as thermally inhibited starches as disclosed for example in EP1038882 may also be suitable for use herein. Preferably, the starch is native wheat starch.

In the present invention, substantially all the starch in the pellet did not undergo major physico-chemical modification during the pelletization process. For example, when native starch is used as starting material for the production of the pellet, substantially all the starch is still native in the pellet.

Preferably, the pellet is further characterized in that the starch is substantially not gelatinized. Starch gelatinization is a well known phenomenon in the art; it is a process that breaks down the intermolecular bonds of starch molecules in the presence of water and heat, allowing the hydrogen bonding sites to engage more water. This irreversibly dissolves the starch granule. Under the microscope in polarized light, starch loses its birefringence and its Malthese cross. Thus under the microscope in polarized light, starch that is not gelatinized still has its birefringence and the Malthese cross is visible.

For the purpose of the present invention, the pellet comprises preferably from 5 to less than 75 w/w % of protein, preferably from 5 to 70 w/w % of protein, more preferably from 15 to 60 w/w % of protein, even more preferably from 20 to 50 w/w % of protein, yet even more preferably from 30 to 50 w/w % of protein. For the purpose of the present invention, protein content is determined by nitrogen content, applying a factor of 5.7 for the conversion of Nitrogen content to amino acid content: Protein=5.7*N.

For the purpose of the present invention, the protein can be any suitable vegetal or animal protein, such as for example from cereals, beans, pea, soy, milk, whey, algae, blood, fish meal or mixtures of one or more thereof. The protein can be native or partially or totally hydrolyzed or otherwise modified. Preferably the protein is cereal protein, more preferably gluten. Said gluten can be vital or partially or totally devitalized. Hydrolysed wheat protein can be obtained for example such as described in EP 1969950A1. More preferably, the protein is vital gluten. In the most preferred embodiment, the protein is vital wheat gluten,

Typically commercially available vital wheat gluten comprises, on dry base, from about 70 w/w % to about 80 w/w % of crude proteins (P=5.7*N).

In the present invention, the protein does not undergo major physico-chemical modification during the pelletizing process. For example, when vital wheat gluten is the protein, substantially all the gluten in the pellet is still vital.

For example, the pellet of the present invention can comprise from 20 to 75 w/w % db starch and from 5 to 70 w/w % db protein. In other embodiments, the pellet of the present invention can comprise, from 30 to 70 w/w % db starch and from 15 to 70 w/w % db protein. In other embodiments, the pellet of the present invention can comprise from 20 to 65 w/w % db starch and from 20 to 65 w/w % db protein. In other embodiments, the pellet of the present invention can comprise from 25 to 60 w/w % db starch and from 25 to 55 w/w % db protein. In other embodiments, the pellet of the present invention can comprise from 30 to 50 w/w % db starch and from 30 to 50 w/w % db protein. In other embodiments, the pellet of the present invention can comprise from 40 to 45 w/w % db starch and from 35 to 40 w/w % db protein.

The pellet of the present invention can comprise fibre. Fibre can be present for example due to the presence of bran. Bran can be derived from any type of cereal, such as wheat, corn, barley, oats and the like, and from soy. Bran can be added when the food-, feed- or pet food composition should contain bran, for example for nutritional reasons. In certain embodiments of the present invention, the pellet comprises 10 w/w % db bran or less, more preferably it comprises 5 w/w % db bran, or even 3 w/w % db bran, even 1 w/w % db of bran or less. Low amount of bran is especially desirable for pellets which are destined to the fish industry: as bran is not digested by the fish, it does not bring any nutritional value and therefore not bring any commercial value in such a pellet.

Further, the pellet of the present invention can comprise fat, vitamins, or other kinds of additives, such as colouring agents, flavouring agents and the like.

For the purpose of the present invention, it is desirable that the pellet is not expanded or expanded only to a limited extent. With expansion is meant a change of volume due to a sudden and consequent change of pressure and temperature at the exit of the apparatus.

Thus the pellet of the present invention has a diameter being minimum equal to the diameter of the die-holes of the pelletizer and maximum 5% higher than the diameter of the die-holes of the pelletizer.

Further the pellet of the present invention is characterized by a Holmen durability value of equal or higher than 85%, preferably higher than 90% (which describes a high resistance to abrasion) and a Kahl hardness of equal or higher than 6 (which describes a high resistance to breaking). Holmen durability is a well known measure of resistance to abrasion and is measured with Holmen Pellet Tester, such as for examples NPH200. Kahl hardness is a well known measure of resistance to breaking.

In another aspect, the present invention relates to a process for making a pellet. Preferably, the present invention relates to a process for making the pellet of the present invention.

The process of the present invention comprises the steps of:
1. Preconditioning a product by providing heated air and/or steam such that the temperature of the product reaches values of from 10 to 95° C. and/or such that the moisture content of the product is increased by 1 to 5 w/w %, and
2. Passing the preconditioned product through a die hole for obtaining pellets, and
3. Air cooling the pellets

Preferably the product in step 1. is a powder product. The powder product to be pelletized is preconditioned by being introduced into an equipment where it is mixed, heated and/or moistured by injection of conditioned air (i.e. air at such conditions that it brings heat and/or moisture), hot water and/or steam. Preferably steam is used.

Pre-conditioner devices can contain one or two mixing/conveying elements which consist of rotating shafts with radically attached pitched paddles. The equipment used for pre-conditioning includes atmospheric or pressurized chambers.

The product to be pelletized can be brought directly into a pellet mill when it is equipped with an additional inlet for dry air, hot water and/or steam.

The heated air and/or steam during preconditioning is such that the powder product to reaches a temperature of from 10 to 95° C., preferably from 50 to 95° C., more preferably from 50 to 90° C., even more preferably from 50 to 80° C., yet even more preferably from 50 to 70° C., yet even more preferably from 50 to 60° C., yet even more preferably from 55 to 60° C. The choice of the temperature of the air and/or steam can easily be determined by the skilled person. It can be conveniently from 10 to 200° C., preferably 50 to 150° C., more preferably from 100 to 150° C.

Moisture is added in such an amount that the moisture content of the powder product is increased by 1 to 5%, preferably by 2 to 3%. Moisture is calculated from the weight loss after drying at 103° C. in an oven during 4 hours. When moisture is added, it is conveniently added with the steam or by spraying water on the product.

The preconditioned product is still in powder form. Under powder is understood that the product is made of particles which are not cemented together. The low amount of moisture addition, if any, does not cause the product to become a paste.

The pre-conditioned product is then conveyed into a pellet mill equipped with die holes for obtaining pellets.

The configuration of the dies and die-holes of the pellet mill is such that the ratio (A) of Length to Diameter is from 3 to 20. More preferably, the ratio A is from 5 to 15, even more preferably from 7 to 13.

The temperature of the product before entering the dies of the pellet mill is chosen from 10 to 95° C. The temperature is chosen such that the pellets coming out of the dies of the pellet mill do not stick or are not deformed (i.e. curved, cracked, . . . ), nor expanded.

The pellets shape can be changed by adapting the dies of the pellet mill.

Air cooling, typically cooling with air at ambient temperature, of the pellets can be achieved by passing the pellets through any type of air cooling: types of coolers as commonly used in feed pelletizing lines, horizontal, vertical, counterflow coolers and the like. An advantage of the present invention is that the pellets do not require a drying step with high energy input: damping after pelletization, transport and air cooling is sufficient to bring the pellets to the desired moisture content. Typically, part and preferably all the amount of moisture added during preconditioning, if any, is removed during air cooling.

The process may comprise a further step of treating the pellets with steam for 1 to 30 seconds, before air cooling. This step allows the surface of the pellet to be hardened. The thickness of the hardened layer will increase with the length of steam treatment and will affect the durability of the resulting pellet. It will thus improve the resistance of the pellet against physical stress for instance during storage, transport and distribution.

The product to be pelletized can be a blend of starch and protein. The product to be pelletized can be a blend of a starch source and a protein source. It can also be one and only starch and protein source, such as wheat flour for example. It can also be a blend of a starch source and a protein, such as a blend of flour and protein. The product to be pelletized is typically a powder product, i.e. composed of particles that are not cemented together.

Starch can be derived from any source (starch source). The starch used for the current invention is obtained from a source selected from the group of native leguminous starch, native cereal starch, native root starch, native tuber starch, native fruit starch, native algae starch, modified leguminous starch, modified cereal starch, modified root starch, modified tuber starch, modified fruit starch, modified algae starch, waxy type starches, high amylase starches or mixtures thereof. Typical sources for the starch are cereals, tubers, roots, legumes, fruit, algae and hybrid starches. Suitable sources include but are not limited to wheat, corn, pea, potato, sweet potato, sorghum, banana, barley, rice, sago, amaranth, tapioca, arrowroot, cane and low amylose (containing no more than about 10% by weight amylose, preferably no more than 5%) or high amylose (containing at least about 40% by weight amylose) varieties thereof. Also suitable are starches derived from a plant obtained by breeding techniques including crossbreeding, translocation, inversion, transformation or any other method of gene or chromosome engineering to include variations thereof. In addition, starch derived from a plant grown from artificial mutations and variations of the above generic composition, which may be produced by, known standard methods of mutation breeding, are also suitable herein. Modifications are intended to include chemical modifications and/or physical modifications. The chemical modifications are intended to include without limitation, pregelatinised starches, acetylated starches, hydroxyethylated and hydroxypropylated starches, inorganically esterified starches, cationic, anionic, oxidized starches, zwitterionic starches, starches modified by enzymes, and combinations thereof. Physically modified starches such as thermally inhibited starches as disclosed for example in EP Patent No, 1 038 882 may also be suitable for use herein. Preferably, the starch is native wheat starch. Preferably, starch is as described in the first aspect of the present invention.

Protein is as described in the first aspect of the present invention. The amounts of starch and protein are as described in the first aspect of the present invention.

Suitable starch sources include but are not limited to cereals, pea, potato, sweet potato, banana, sago, amaranth, tapioca, arrowroot, cane and low amylose (containing no more than about 10% by weight amylose, preferably no more than 5%) or high amylose (containing at least about 40% by weight amylose) varieties thereof. The cereal can be wheat, corn, sorghum, barley, rice and the like. Preferably wheat is used. Preferably the cereal is milled prior to be used in the process of the present invention. The starch source is thus preferably flour.

Therefore, in one embodiment, flour is preconditioned.

In other embodiments, the product to be pelletized is a blend of flour and protein. Said blend comprises from about 5 w/w % to about 95 w/w % of flour and from about 5 w/w % to about 95 w/w % of protein. In other embodiments, the blend comprises from about 20 w/w % to about 80 w/w % of flour and from about 20 w/w % to about 80 w/w % of protein. In yet other embodiments, the blend comprises from about 30 w/w % to about 70 w/w % of flour and from about 30 w/w % to about 70 w/w % of protein. In yet other embodiments, the blend comprises from about 40 w/w % to about 60 w/w % of flour and from about 40 w/w % to about 60 w/w % of protein. In yet another embodiment, the blend comprises about 50 w/w % of flour and about 50 w/w % of protein.

Preferably, flour is wheat flour and protein is vital wheat gluten. In a further preferred embodiment, flour is what is generally known as white wheat bakery flour which comprises from about 70 to 75 w/w % starch, from 9 to 13 w/w % vital gluten and about 14 w/w% moisture, In another embodiment, flour is feed quality flour.

For the purpose of the present invention, it is desirable that the pellet does not expand or expands only to a limited extent when coming out of the dies of the pellet mill. With expansion is meant a change of volume due to a sudden change of pressure and temperature. Thus the pellet of the present invention has a diameter being minimum equal to the diameter of the die-holes of the pelletizer and maximum 5% higher than the diameter of the die-holes of the pelletizer. The degree of expansion is measured as follows:

% expansion=(average pellet diameter*100)/die hole diameter.

In another aspect, the present invention relates to a method for making a food-, feed- or pet food composition, comprising grinding the pellet of the present invention and mixing it with other ingredients. It can be suitable in some embodiments to first mix the pellet with other ingredients or micronutrients, or other pellets and then grind.

Grinding the pellet can be achieved with any suitable grinding equipment known in the art. The granulometry of the ground pellet depends on the application to which it is intended. The person skilled in the art of making food-, feed- or pet food compositions will easily determine which granulometry is suitable per application.

The ground pellet is then mixed with other ingredients to make food-, feed- or pet food compositions.

In one embodiment, the pellet is ground and mixed with other ingredients such as to make a fish feed composition. These other ingredients may comprise oil, fat, vitamins and the like, in amounts suitable to make a fish feed composition. Preferably the fish feed composition is further texturized for example by extrusion. The resulting feed product can be an extruded product it can also be a pelletized product.

In another embodiment, the pellet is ground and mixed with other ingredients such as to make a pet food composition. These other ingredients may comprise oil, fat, fibre, vitamins and the like in amounts suitable to make a pet food composition. Preferably, the pet food composition is further texturized for example by extrusion. The resulting pet food product can be an extruded product it can also be a pelletized product.

In another embodiment, the pellet is ground and mixed with other ingredients such as to make a food composition. These other ingredients may comprise oil, fat, vitamins, fibers, vitamins and the like in amounts suitable to make a food composition. The food composition can be further tabletted or otherwise compressed, or texturized for example by extrusion.

In another aspect, the present invention relates to use of the pellets of the present invention to make food-, feed- or pet food compositions. In particular the pellets can be used to make fish feed compositions or piglet feed compositions.

In another aspect, the present invention relates to the use of the pellet as a starch source in industrial processes, such as for example industrial processes for making paper or cardboards. For example the pellet can be used as such to make a suitable starch slurry for paper making, or the pellet can be ground and then used to make a suitable starch slurry for paper making.

The invention will be illustrated by the following examples.

### EXAMPLES

### Example 1

A blend of 30 w/w % vital wheat gluten (Gluvital 21040, Cargill) and 70 w/w% wheat flour (Meneba, heat treated wheat flour, feed quality 14.7 w /w % moisture, 83/3 w/w % db starch, 9.94 w/w% db protein) was made. The moisture content of the blend is 12.2%. The blend was, at a rate of 660 kg/h, consecutively:
Pre-conditioned in a pre-conditioner where steam at 2.5 bar was added to increase the temperature of the blend from ambient temperature to about 53° C. and the moisture content to about 14.7%
Passed through a Geesen V3-30 pellet mill equipped with a die with ratio A of 45/5 (mm/mm), and then
Cooled to room temperature by air cooling.

The pellets came out of the pellet mill with a temperature of about 82° C.

The moisture content of the pellets after cooling down was 13%.

Microscopic evaluation showed comparable levels of native starch in the products before and after pelletizing.

The Holmen Durability is measured at 941%.

The Kahl Hardness measured is 15 (Kahl number).

The pellet expansion measured is 1.5%.

### Example 2

A blend of 50 w/w % vital wheat gluten (Gluvital 21060, Cargill) and 50 w/w% wheat flour (Meneba, same quality as in example 1) was made. The moisture content of the blend is 11.2%. The blend was, at a rate of 600 kg/h, consecutively:
Pre-conditioned in a pre-conditioner where steam at 2.5 bar was added to increase the temperature of the blend from ambient temperature to about 42° C., and then
Passed through a Geesen V3-30 pellet mill equipped with a die with ratio A of 45/5 (mm/mm), and then
Cooled to room temperature by air cooling

The pellets came out of the pellet mill with a temperature of about 78° C.

The moisture content of the pellets after cooling down was 11.3%.

Microscopic evaluation showed comparable levels of native starch in the products before and after pelletizing.

The Holmen Durability is measured at 92.2%.

### Example 3

Wheat flour (Meneba, same quality as in example 1) with a moisture content of 14.6% was, at a rate of 650 kg/h, consecutively:
Pre-conditioned in a pre-conditioner where steam at 2.5 bar was added to increase the temperature of the blend from ambient temperature to about 53° C., and the moisture content to about 17.6%
Passed through a Geesen V3-30 pellet mill equipped with a die with ratio A of 45/5 (mm/mm), and then
Cooled to room temperature by air cooling.

The pellets came out of the pellet mill with a temperature of about 78° C.

The moisture content of the pellets after cooling down was 15.1%.

Microscopic evaluation showed comparable levels of native starch in the products before and after pelletizing.

The Holmen Durability is measured at 87.9%.

The Kahl Hardness measured is 6 (Kahl number).

The pellet expansion measured is 2.8%

### Example 4

A blend of 30 w/w % partially hydrolyzed wheat protein (C*HyProW 21100, Cargill) and 70 w/w % wheat flour (Meneba, same quality as in example 1) was made. The moisture content of the blend is 11.4%. The blend was, at a rate of 650 kg/h, consecutively:
Pre-conditioned in a pre-conditioner where steam at 2.5 bar was added to increase the temperature of the blend from ambient temperature to about 49.7° C. and the moisture content to about 13.6%
Passed through a Geesen V3-30 pellet mill equipped with a die with ratio A of 45/5 (mm/mm), and then
Cooled to room temperature by air cooling.

The pellets came out of the pellet mill with a temperature of about 78° C.

The moisture content of the pellets after cooling down was 12.7%.

Microscopic evaluation showed comparable levels of native starch in the products before and after pelletizing.

The Holmen Durability is measured at 96%.

The Kahl Hardness measured is 14 (Kahl number).

The pellet expansion measured is 0%

1. A pellet comprising
starch;
from 5 to less than 75 weight/weight % protein, based on the dry weight of the pellet (w/w % db); and
a moisture content of 20 weight/weight % (w/w %) or less.

2. The pellet according to claim 1, wherein a majority of the starch is not gelatinized.

3. The pellet according to claim 1, characterized in that the pellet comprises comprising at least 20% weight/weight starch, based on the dry weight of the pellet (w/w % db).

4. The pellet according to claim 1, wherein the starch is a native starch, a modified starch, or mixtures thereof

5. The pellet according to claim 1, wherein the protein is gluten.

6. The pellet according to claim 1, wherein the protein is vital gluten, devitalised gluten, hydrolysed gluten or mixtures thereof.

7. The pellet according to claim 1 having a moisture content of from 6 to 20 w/w %.

8. A method for making a food, a feed, or a pet food product comprising:
1. grinding the pellet of claim 1; and
2. mixing the grindedpellet with other ingredients.

9. The method according to claim 8, wherein the food product is a tablet or a chewing gum.

10. The method according to claim 8, wherein the feed product is an extruded product or a pelletized product.

11. The method according to claim 8, wherein the pet food is an extruded product or a pelletized product.

12. A process to make a pellet, comprising:
Preconditioning a powder product by providing heated air or steam such that the temperature of the powder product reaches values of from 10 to 95° C. or such that the moisture content of the powder product is increased by 1 to 5 w/w %;
Passing the preconditioned powder product through a die hole for obtaining pellets; and
Air cooling the pellets.

13. The process of claim 12, wherein the powder product comprises starch and protein.

14. The process of claim 12, wherein the powder product comprises from 5 to 95 w/w % of flour and from 5 to 95 w/w % of vital wheat gluten.
